(19) United States
(12) Patent Application Publication
(10) Pub. No.: US 2019/0132312 A1
(43) Pub. Date: May 2, 2019

(54) Universal Identity Validation System and Method

(71) Applicant: Paul Jennings Dotto, Fredericksburg, VA (US)

(72) Inventor: Paul Jennings Dotto, Fredericksburg, VA (US)

(73) Assignee: Sky ID Inc., Fredericksburg, VA (US)

(21) Appl. No.: 16/170,710

(22) Filed: Oct. 25, 2018

Related U.S. Application Data
(60) Provisional application No. 62/577,653, filed on Oct. 26, 2017.

(51) Int. Cl. H04L 29/06; G06F 21/62

(52) U.S. Cl. CPC H04L 63/0861; G06F 21/6245; H04L 63/062

(57) ABSTRACT

The Universal Identity Validation System and Method (UIVSM) is a novel system and method for validating identity of membership on behalf of third-party entities. The UIVSM will validate identity for in-person and cyber-based interactions. Embodiments of this invention relate to the collection of enough biometric attribute information from an individual during enrollment at a supervised biometric scanning site to provide for the capability to revalidate this individual's identity during future biometric scans at supervised biometric scanning sites with an extremely high degree of accuracy. A plurality of method-operator controlled supervised biometric scanning sites will be deployed across the region for which UIVSM services are offered, as individuals must be physically present at a method-operator supervised biometric scanning site for a supervised biometric scan. Gathered biometric attribute information from enrolled persons will be stored in an information store, so individuals may not re-enroll.

### BACKGROUND

Individuals and organizations cannot conveniently, efficiently, nor effectively validate identity. Identity theft is an everyday occurrence even with recent advances in biometric capture technology. Furthermore, personally identifiable information (PII) such as name, date of birth, social security number (SSN), and other elements is used as the basis for identity by most, if not all, entities (within both the private and public-sector spheres). Malicious actors may easily assume identity for fraudulent purposes after obtaining relevant PII.

In the traditional paradigm of identity validation, the identity validator would assess some combination of personally identifiable information to ensure the provided data is consistent with data on-record. For example, a combination of social security number, date of birth, name, and address information might be utilized to ensure that the person is indeed the person so claimed. It is assumed only the actual person associated to this PII would have access to such information and this information would be kept confidential. Obviously, such information cannot be kept confidential and identity thieves have used access to such information to execute fraudulent transactions using assumed identities. In the more recent past, identity validation processes have become more involved, querying recent credit card transactions, past addresses, names and associated information of family members, etc. Though this methodology is somewhat more secure than just asking for a social security number and date of birth, it is again vulnerable to abuse due to reliance on supposedly confidential information.

Some public and private-sector organizations have begun utilizing biometric attribute information to improve identity validation. Identity validation systems incorporating biometric attribute information provide a better basis for identity validation as this information represents physical characteristics of the human body. Individuals can be biometrically scanned and then rescanned to observe if the biometric attribute information from the contemporaneous scan matches the biometric attribute information on-record from the original scan.

For many reasons, advances in biometric capture technology have not solved the identity validation problem. Each entity (company, government agency, non-profit, etc.) desiring to validate identity must create and operate infrastructure to establish identity, validate identity, and re-validate identity. Maintaining this infrastructure is expensive. Furthermore, the expenditures required to establish and maintain such a system are completely borne by the entity requiring the identity validation. Even with biometric validation of identity, the individual could associate his/her valid biometric attributes to fraudulent PII. Until an individual has established a long-standing relationship, the entity does not know if the identity claimed is legitimate.

Identity validation is not a core function of existing entities. For example, commercial banks are in the business of providing deposit accounts, making loans, and facilitating payments. Banks would prefer to focus on these revenue-producing activities (their core business activities) and not on identity validation. The same could be said for a government agency. The United States Internal Revenue Service would prefer to focus on evaluating a taxpayer's submitted tax return and processing the associated refund or collection, not on verifying that the individual submitting the return is indeed the person represented on the return. Since the identity validation process operates as a cost-center as opposed to a revenue-center, entities are incentivized to reduce the costs of identity validation even if this leads to customer inconvenience and/or an acceptable level of identity theft.

Biometric attribute information is not by nature confidential. PII, such as a social security number (SSN), can—at least theoretically—be kept secret. Inexpensive fingerprint capture tools (such as those commonly used by law enforcement personnel) could obtain fingerprint attribute information without the knowledge nor consent of the person associated to the fingerprints. Likewise, with an advanced camera system, a quick photo could be taken without permission of the subject which would provide iris biometric attribute information.

Such biometric information could then be used to authenticate identity in a fraudulent manner using today's biometric identification validation systems. Nefarious actors have produced 3D-printed fingers and specially imaged contact lenses designed to defeat biometric identity validation systems. Mobile phone application authentication systems, utilizing the phone's video capture capability for identity validation, have been duped with pre-recorded video of the victim's face and savvy coding skills.

The problems identified here have hindered the convenient and efficient use of biometric-based identity validation. Systems and methods capable of overcoming these limitations do not currently exist.

### BRIEF SUMMARY

Embodiments of the present invention, the Universal Identity Validation System and Method (UIVSM), relate to a system and method for validating identity which overcomes the limitations of current identity validation practices as described in the background section.

Embodiments of this invention relate to the collection of enough biometric attribute information from an individual during enrollment at a supervised biometric scanning site to provide for the capability to revalidate this individual's identity during future biometric scans at supervised biometric scanning sites with an extremely high degree of accuracy. A plurality of method-operator controlled supervised biometric scanning sites will be deployed across the region for which UIVSM services are offered, as individuals must be physically present at a method-operator supervised biometric scanning site for a supervised biometric scan. Eventually, the region may encompass an entire nation or many nations. Gathered biometric attribute information from enrolled persons will be stored in an information store, so individuals may not re-enroll. If an individual attempts reenrollment into the UIVSM, the UIVSM will detect a match after comparison of the individual's biometric attribute information with that previously collected. The enrollment process at this point is aborted. Though personally identifiable information (PII) may be associated to the individual's record, the basis of identity for the UIVSM is the gathered biometric attribute information and not the associated PII.

Embodiments of the UIVSM may include verifying an interaction (e.g., transaction) for a member at the request of a third-party entity via a supervised biometric scan. Other embodiments of the UIVSM include the issuance of a security token to an individual after a supervised biometric scan. The authentication of the security token could validate identity for cyber and in-person interactions between an individual and a third-party entity.

The claims encompass one independent system claim and two independent method claims. The independent system claim and one of the independent method claims concern a physical identity validation on behalf of a third-party entity. A dependent system claim and the other independent method claim concern a cyber identity validation on behalf of a third-party entity utilizing a security token.

Several advantages of one or more aspects of the UIVSM are: a cost-efficient and commercially practicable method for providing identity validation services to all entities which require such services; a very high degree of identity validation assurance due to biometric scanning only occurring at method-operator controlled sites while under supervision; the utilization of physical biometric attributes as the basis of identity as opposed to artificially created data such as names, social security numbers, and other PII. Another advantage of one or more aspects is the UIVSM does not require confidentiality of centrally-stored information, such as the collected biometric attribute information and associated PII. Therefore, the UIVSM information store (a database in one embodiment) could be compromised by malicious actors and the UIVSM could continue to provide identity validation services completely unimpeded by the unauthorized disclosure of information and UIVSM membership would not be at increased risk of identity theft within the UIVSM framework.

These and other advantages of one or more aspects will become apparent from a consideration of the ensuing description and accompanying drawings.

### BRIEF DESCRIPTION OF THE DRAWINGS

FIG. 1 is a simplified diagram of the Universal Identity Validation System 100, according to one embodiment of the invention.

FIG. 2 is a simplified diagram of the Universal Identity Validation System 200, according to one embodiment of the invention.

FIG. 3 is a simplified flow diagram illustrating the Enrollment Process 300 for the Universal Identity Validation Method, according to one embodiment of the invention.

FIG. 4 is a simplified flow diagram illustrating the Enrollment Process 400 for the Universal Identity Validation Method, according to one embodiment of the invention.

FIG. 5 is a simplified flow diagram illustrating the Cyber Identity Validation Process 500 for the Universal Identity Validation Method, according to one embodiment of the invention.

FIG. 6 is a simplified flow diagram illustrating the Physical Identity Validation Process 600 for the Universal Identity Validation Method, according to one embodiment of the invention.

FIG. 7 is a simplified flow diagram illustrating the Reissuance of a Security Token Process 700 for the Universal Identity Validation Method, according to one embodiment of the invention.

### DETAILED DESCRIPTION

This nonprovisional patent application makes a claim under 35 U.S.C. § 119(e) for the benefit of a prior provisional patent application with the same title of invention as contained in this nonprovisional patent application. See provisional patent application No. 62/577,653 filed on Oct. 26, 2017.

The Universal Identity Validation System and Method (UIVSM) is a novel system and method for validating identity of membership on behalf of third-party entities. The UIVSM will validate identity for in-person and cyber-based interactions.

This invention is not limited in its application to the details of construction and the arrangement of components set forth in the following description or illustrated in the drawings. The invention is capable of other embodiments and of being practiced or of being carried out in various ways. Also, the phraseology and terminology used herein is for description and should not be regarded as limiting. The use of “including,” “comprising,” “having,” “containing,” “involving,” and variations thereof herein is meant to encompass the items listed thereafter and equivalents thereof as well as additional items.

Terminology in the claims and the drawings should be defined at their broadest reasonable latitude within the context of the claims and drawings and these definitions serve to highlight possible embodiments but not to limit the scope of the terms.

An “information store” is a device which receives, stores, maintains, retrieves, searches, compares, queries and transmits information and is capable of conducting other appropriate tasks. For example, a traditional computer database would be considered one embodiment of an information store.

A “security token” is a uniquely identified instrument, whether physical in nature or purely software-based, which provides for authentication. Commonly used smart-chip based credit cards would be considered security tokens.

A “third-party entity” is any party with a need to validate identity. A third-party entity could be a for-profit company, a government agency, a non-profit organization, a person, and other formations.

A “unique key” is a set of information that is unique as compared with all previously created sets of information within the system. A unique key could be an alpha or a numeric or a combined alpha/numeric series of characters. A social security number is an example of 9-digit numeric-character unique key.

A “biometric scan” is the act of capturing and recording the biometric identifiers¹ of a human being. ¹ Biometric identifiers are often categorized as physiological versus behavioral characteristics. Physiological characteristics are related to the body. Examples include, but are not limited to fingerprint, palm veins, face recognition, DNA, palm print, hand geometry, iris recognition, retina and odor/scent. Behavioral characteristics are related to the pattern of behavior of a person, including but not limited to typing rhythm, gait, and voice.

“Supervised biometric scanning” is conducting a biometric scan under method-operator supervision using method-operator controlled equipment to ensure that the biometric scan is executed accurately and consistently, with integrity and without artifice.

A “supervised biometric scan” is the act of supervised biometric scanning.

A “supervised biometric scanning site” is method-operator controlled space at which supervised biometric scanning occurs.

An “individual” is a person interacting with a third-party entity and the person subject to identity validation at the request of the third-party entity.

An “interaction” is a transaction, communication, release of information, or any other dealing between an individual and a third-party entity.

“To interact” is to have an interaction.

A “security token validation apparatus” is a system with all necessary components which provides for the authentication of a security token.

An “identity validation” provides for the verification of a person's claim as to whom he/she is by means of the systems and methods described within this patent application.

A “physical identity validation” is an identity validation by means of a supervised biometric scan at a supervised biometric scanning site.

A “cyber identity validation” is an identity validation by means of security token authentication.

A “cyber interaction” is a network-based interaction. A purchase of goods via a third-party entity's website or mobile phone application (phone app) would be considered a cyber interaction.

An “in-person interaction” is an interaction at which both an individual and a representative of the third-party entity are physically present.

A “member” is an individual who has enrolled in the UIVSM.

“Membership” is a collective reference to all individuals enrolled in the UIVSM.

The “method-operator” is the entity—and the persons/employees acting on behalf of the entity—utilizing the systems and methods described within this patent application.

“Personally identifiable information (PII)” is information which society uses to identify persons. Examples of such information is: name, social security number, driver license number, alien registration number, date of birth/place of birth, current and previous addresses.

A “device” is a computer, mobile phone, tablet, or other similar instrument which can communicate over a network, such as the internet, and interface with a security token.

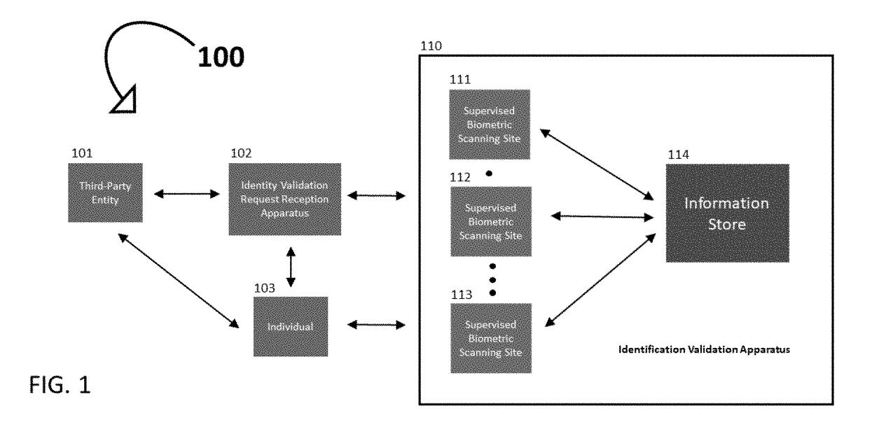

FIG. 1 is a simplified diagram of the Universal Identity Validation System 100, according to one embodiment of the invention. In this embodiment, the System 100 comprises a Third-Party Entity 101. The Third-Party Entity 101 interacts with an Individual 103. The Third-Party Entity 101 requests Individual 103 communicate his/her unique key to the Third-Party Entity 101. Individual 103 communicates his/her unique key to the Third-Party Entity 101. The Third-Party Entity 101 requests a physical identity validation of Individual 103 and the release of PII if desired by communicating the received unique key and the PII-request to the Identity Validation Request Reception Apparatus (IVRRA) 102. In one embodiment, the IVRRA 102 is an internet-accessible mechanism provided via an application programming interface (API). Upon receipt of the request from Third-Party Entity 101, the IVRRA 102 transmits the request to the Identification Validation Apparatus 110.

The Identification Validation Apparatus 110 is a sub-system within the System 100 and consists of Supervised Biometric Scanning Sites 111, 112, 113, and Information Store 114. The Identification Validation Apparatus 110 consists of a plurality of supervised biometric scanning sites, represented by Supervised Biometric Scanning Sites 111, 112, and 113. The three dots between Supervised Biometric Scanning Sites 112 and 113 on the FIG. 1 diagram indicate the number of Supervised Biometric Scanning Sites is not bounded and may fluctuate with the membership level and geographical dispersion of the membership. The sites, in one embodiment, are fixed and/or mobile in nature and dispersed across a geographic region for the purpose of physical proximity to the UIVSM's membership. Each of the Supervised Biometric Scanning Sites 111, 112, and 113 is linked with the Information Store 114. In one embodiment, the Information Store 114 is a network-accessible database.

A member or prospective member interfaces with the Identification Validation Apparatus 110 when presenting him/herself for supervised biometric scanning at one of the Supervised Biometric Scanning Sites 111, 112, or 113 to initially enroll in the system, update a record, or conduct a physical identity validation at the request of the third-party entity. With previously gathered biometric attribute information obtained during enrollment maintained in the Information Store 114, the Identification Validation Apparatus 110 compares the results of a contemporaneous biometric scan conducted at a Supervised Biometric Scanning Site 111, 112, or 113 with stored biometric attribute information maintained in the Information Store 114 to ensure that the person physically present is the enrolled member with the claimed unique key. New members are given a unique key upon enrollment into the UIVSM and their biometric attribute information is associated to the unique key in the Information Store 114.

The Identification Validation Apparatus 110 confirms that a record with the specified unique key exists in the Information Store 114. If a matching record exists, contact information for this member, presumably Individual 103, is transmitted to the IVRRA 102. The IVRRA 102 then contacts the member and provides identifying details regarding the interaction between Individual 103 and Third-Party Entity 101 which necessitated the physical identity validation. The member is requested to validate the legitimacy of the interaction by presenting him/herself at Supervised Biometric Scanning Site 111, 112, or 113 for the execution of a physical identity validation on behalf of Third-Party Entity 101.

After a supervised biometric scan confirms that the person physically present at Supervised Biometric Scanning Site 111, 112, or 113 is the member with the unique key given by Individual 103, the member is presumed to be Individual 103 and the interaction between Third-Party Entity 101 and Individual 103 is considered legitimate. Individual 103 may approve the release of personally identifiable information (PII) as requested by Third-Party Entity 101. If approval is received, the Identification Validation Apparatus 110 retrieves appropriate PII from the Information Store 114. Identification Validation Apparatus 110 communicates to IVRRA 102 that a physical identity validation occurred, affirming the legitimacy of the interaction between Individual 103 and Third-Party Entity 101, and provides requested PII if Individual 103 approved the release. The IVRRA 102 communicates acknowledgement of a successful physical identity validation and PII approved for release to Third-Party Entity 101.

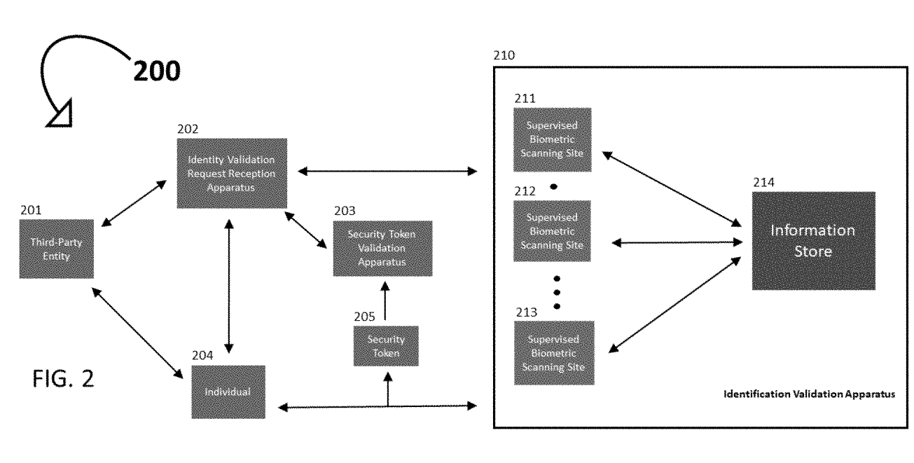

FIG. 2 is a simplified diagram of the Universal Identity Validation System 200, according to one embodiment of the invention. In this embodiment, the System 200 comprises a Third-Party Entity 201. The Third-Party Entity 201 interacts with an Individual 204. The Third-Party Entity 201 requests Individual 204 communicate his/her unique key to the Third-Party Entity 201. Individual 204 communicates his/her unique key to Third-Party Entity 201. The Third-Party Entity 201 requests a cyber identity validation of Individual 204 and the release of PII if desired by communicating the received unique key and the PII-request to the Identity Validation Request Reception Apparatus (IVRRA) 202. In one embodiment, this is an internet-accessible mechanism provided via an application programming interface (API). Upon receipt of the request from Third-Party Entity 201, the IVRRA 202 transmits the request to the Identification Validation Apparatus 210.

The Identification Validation Apparatus 210 is a sub-system within the System 200 and consists of Supervised Biometric Scanning Sites 211, 212, 213, and Information Store 214. The Identification Validation Apparatus 210 consists of a plurality of supervised biometric scanning sites, represented in the sketch by Supervised Biometric Scanning Sites 211, 212, and 213. The three dots between Supervised Biometric Scanning Site 212 and 213 on the FIG. 2 diagram indicate the number of Supervised Biometric Scanning Sites is not bounded and may fluctuate with the membership level and geographical dispersion of the membership. The sites, in one embodiment, are fixed and/or mobile in nature and dispersed across a geographic region for the purpose of physical proximity to the UIVSM's membership. Each of the Supervised Biometric Scanning Sites 211, 212, and 213 is linked with Information Store 114. In one embodiment, the Information Store 114 is a network-accessible database.

New members are issued a Security Token 205 and given a unique key upon enrollment into the UIVSM and their biometric attribute information and security token are associated to the unique key in the Information Store 214. Security Token 205 is physically issued directly to members at Supervised Biometric Scanning Site 211, 212, or 213. A member or prospective member interfaces with the Identification Validation Apparatus 210 when presenting him/herself for supervised biometric scanning at one of the Supervised Biometric Scanning Sites 211, 212, or 213 to enroll in the system, update a record, or receive a new Security Token 205 if required due to inoperability, damage, loss, and/or theft of the current Security Token 205; an improvement in security token technology; and/or for some other reason. With previously gathered biometric attribute information obtained during enrollment maintained in the Information Store 214, the Identification Validation Apparatus 210 compares a contemporaneous biometric scan of a member conducted at a Supervised Biometric Scanning Site 211, 212, or 213 with stored biometric attribute information maintained in the Information Store 214 to ensure that the person physically present is the enrolled member with the claimed unique key.

Identification Validation Apparatus 210 confirms a record with the specified unique key exists in the Information Store 214 and is associated to an active security token. If a matching record exists, contact information for this member, presumably Individual 204, is transmitted to the IVRRA 202. The IVRRA 202 contacts the member and provides identifying details regarding the interaction between Individual 204 and Third-Party Entity 201 which necessitated the cyber identity validation. The member is requested to validate the legitimacy of the interaction by means of security token authentication over a network connection.

To conduct a cyber identity validation, the member interfaces the Security Token 205 with the Security Token Validation Apparatus 203. If authenticated, the Security Token Validation Apparatus 203 communicates the identity of the Security Token 205 to the IVRRA 202. The IVRRA 202 queries the Identification Validation Apparatus 210 to obtain the unique key associated to the presented Security Token 205. The Identification Validation Apparatus 210 references the Information Store 214 to obtain the unique key associated to the Security Token 205. If the unique key matches the unique key received from Third-Party Entity 201, the member is presumed to be Individual 204. A network connection is established between the IVRRA 202 and Individual 204. Individual 204 may affirm or deny the validity of the interaction with Third-Party 201 through the IVRRA 202. Individual 204 may also approve the release of personally identifiable information (PII) as requested by Third-Party Entity 201. Identification Validation Apparatus 210 retrieves appropriate PII from the Information Store 214. The IVRRA 202 communicates acknowledgement of a successful cyber identity validation and appropriate personally identifiable information (PII) to Third-Party Entity 101. Individual 204 could interface with the Security Token Validation Apparatus 203 and the IVVRA 202, in various embodiments of the invention, via a website-based application or mobile-phone application used in conjunction with a network-connected device capable of communicating with Security Token 205.

System 200 as described above could also support a member-initiated cyber identity validation process as described below in the Process 500 section.

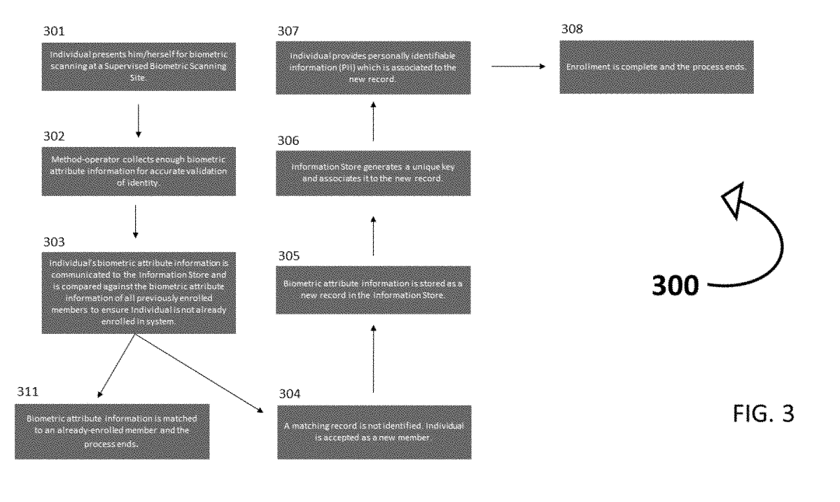

FIG. 3 is a simplified flow diagram illustrating the Enrollment Process 300 for the Universal Identity Validation Method, according to one embodiment of the invention. FIG. 3 depicts the Enrollment Process 300 for an Individual 103. At step 301, Individual 103 presents him/herself at a Supervised Biometric Scanning Site 111, 112, or 113 for supervised biometric scanning. At step 302, the method-operator collects enough biometric attribute information from Individual 103 to provide for accurate validation of identity during future supervised biometric scans. At step 303, the method-operator at Supervised Biometric Scanning Site 111, 112, or 113 communicates collected biometric attribute information to the Information Store 114. The Information Store 114 compares the transmitted biometric attribute information against the biometric attribute information of already-enrolled members stored in Information Store 114. Whether a match is identified or not is transmitted from Information Store 114 to method-operator at Supervised Biometric Scanning Site 111, 112, or 113. If a match is identified, proceed to step 311. At step 311, method-operator at Supervised Biometric Scanning Site 111, 112, or 113 ceases the enrollment process and process 300 ends. If a match is not identified, proceed to step 304. At step 304, Individual 103 is accepted as a new member. At step 305, the biometric attribute information is stored as a new record in the Information Store 114. At step 306, the Information Store 114 generates a unique key and associates it to the new record. At step 307, Individual 103 provides personally identifiable information (PII) to the method-operator at Supervised Biometric Scanning Site 111, 112, or 113, which is communicated to the Information Store 114 and associated to the new record. At step 308, Enrollment Process 300 is complete and the process ends.

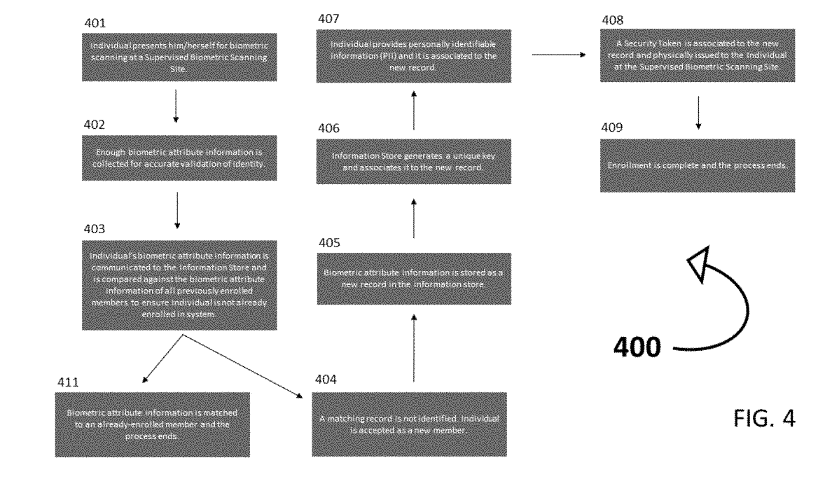

FIG. 4 is a simplified flow diagram illustrating the Enrollment Process 400 for the Universal Identity Validation Method, according to one embodiment of the invention. FIG. 4 depicts the Enrollment Process 400 for an Individual 204. At step 401, Individual 204 presents him/herself at a Supervised Biometric Scanning Site 211, 212, or 213 for supervised biometric scanning. At step 402, the method-operator collects enough biometric attribute information from Individual 204 to provide for accurate validation of identity during future supervised biometric scans. At step 403, the method-operator at Supervised Biometric Scanning Site 211, 212, or 213 communicates collected biometric attribute information to the Information Store 214. The Information Store 214 compares the biometric attribute information against the biometric attribute information of already-enrolled members. Whether a match is identified or not is transmitted from the Information Store 214 to the method-operator at Supervised Biometric Scanning Site 211, 212, or 213. If a match is identified, proceed to step 411. At step 411, method-operator at Supervised Biometric Scanning Site 211, 212, or 213 ceases enrollment process and process 400 ends. If a match is not identified, proceed to step 404. At step 404, Individual 204 is accepted as a new member. At step 405, biometric attribute information is stored as a new record in the Information Store 214. At step 406, the Information Store 214 generates a unique key and associates it to the new record. At step 407, Individual 204 provides personally identifiable information (PII) to the method-operator at Supervised Biometric Scanning Site 211, 212, or 213, which is communicated to the Information Store 214 and associated to the new record. At step 408, method-operator physically issues a Security Token 205 to Individual 204 at Supervised Biometric Scanning Site 211, 212, or 213. The method-operator communicates the identity of the Security Token 205 to the Information Store 214 and the Security Token 205 is associated to the new record. At step 409, Enrollment Process 400 is complete and the process ends.

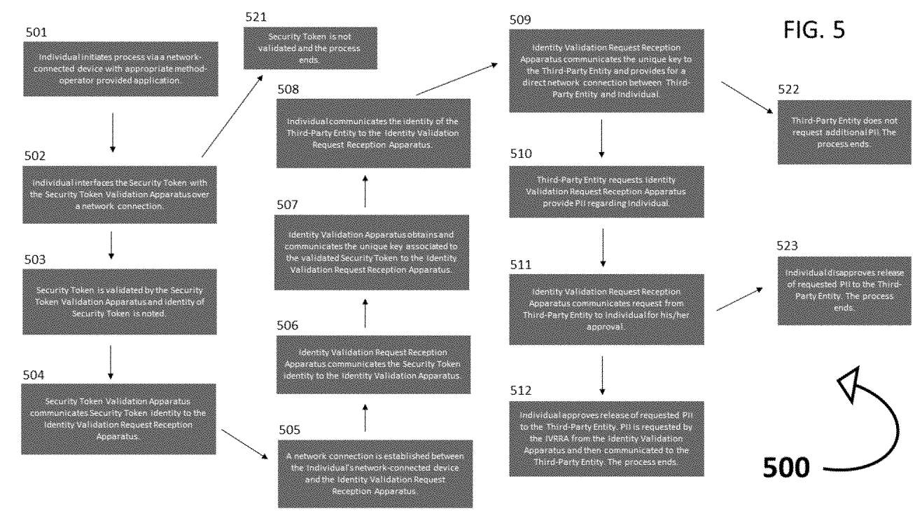

FIG. 5 is a simplified flow diagram illustrating the Cyber Identity Validation Process 500 for the Universal Identity Validation Method, according to one embodiment of the invention. The Cyber Identity Validation Process 500 enables an Individual 204 to validate his/her identity for a cyber interaction with a Third-Party Entity 201. For example, Individual 204 is interacting with a Third-Party Entity 201 website or mobile phone application. At step 501, Individual 204 initiates Cyber Identity Validation Process 500. In various embodiments, this occurs via a device with the appropriate method-operator provided application installed and a network connection. For example, an internet-connected mobile phone with the appropriate mobile-phone application or an internet-connected computer using an internet browser to access a website hosting the appropriate website-based application. At step 502, Individual 204 interfaces his/her Security Token 205 with the Security Token Validation Apparatus 203 via the network-connected device and the method-operator provided application. In various embodiments of the invention, the Security Token 205 is accessible to the internet-connected device by means of Bluetooth technology, NFC (near field communication) technology, and/or a USB-connected reader. Step 502 leads to step 521 or step 503. If Security Token 205 is not validated by the Security Token Validation Apparatus 203, the process ends at step 521. If Security Token 205 is validated by the Security Token Validation Apparatus 203, the identity of the Security Token 205 is noted by the Security Token Validation Apparatus 203 at step 503. At step 504, the Security Token Validation Apparatus 203 communicates the identity of the Security Token 205 to the Identity Validation Request Reception Apparatus (IVRRA) 202. At Step 505, a network connection is established between the Individual 204's network-connected device and the IVRRA 202. At Step 506, the IVRRA 202 communicates the identity of the Security Token 205 to the Identity Validation Apparatus 210. At Step 507, the Identity Validation Apparatus 210 instructs the Information Store 214 to search for the unique key associated to the validated Security Token 205 and communicates the unique key to the IVRRA 202. At Step 508, the Individual 204 communicates the identity of the Third-Party Entity 201 to the IVRRA 202. In various embodiments of the invention, this could be accomplished through the previously mentioned mobile phone or website-based application. The application would provide a directory/listing of participating third-party entities from which Individual 204 selects the appropriate Third-Party Entity 201. At step 509, IVRRA 202 establishes a network connection with Third-Party Entity 201, communicates the unique key to Third-Party Entity 201 and provides for a direct network connection between Individual 204 and Third-Party Entity 201. In one embodiment of the invention, a technology protocol such as OpenID Connect² could be utilized to provide this network connection between the Individual 204 and Third-Party Entity 201. If Third-Party Entity 201 does not request additional personally identifiable information (PII) associated to Individual 204, proceed to step 522. At step 522, the process ends. If Third-Party Entity 201 desires additional personally identifiable information (PII) associated to Individual 204, proceed to step 510. At step 510, Third-Party Entity 201 requests PII associated to Individual 204. Third-Party Entity 201 transmits the PII request to the IVRRA 202. At step 511, the IVRRA 202 communicates the request for PII by Third-Party Entity 201 to Individual 204 for his/her approval. In various embodiments of the invention, this could be accomplished through the previously mentioned mobile phone or website-based application. At step 523, Individual 204 does not approve the release of PII and the process ends. At step 512, Individual 204 approves the release of requested PII to the Third-Party Entity 201. Individual 204 communicates his/her approval to the IVRRA 202. The IVRRA 202 requests the PII associated to the previously specified unique key from Identification Validation Apparatus 210. The Identification Validation Apparatus 210 retrieves the appropriate information from the Information Store 214. After the IVRRA 202 receives the PII from the Identification Validation Apparatus 210, the IVRRA 202 communicates the PII to Third-Party Entity 201. ² See openid.net. OpenID protocols such as OpenID Connect are promoted by the non-profit OpenID Foundation and allows users to be authenticated by co-operating sites using a third-party service, eliminating the need for webmasters to provide their own ad hoc login systems, and allowing users to log into multiple unrelated websites without having to have a separate identity and password for each.

In another embodiment of the invention, the Process 500 is altered and instead the process is initiated directly from a third-party entity's cyber presence. For example, a link on the third-party entity's website landing page provides for the utilization of the process. In such case, the third-party entity website will connect the user to the method-operator website-based application and the altered process will start at step 502. In this case, step 508 is unnecessary as the Third-Party Entity 201 has already been identified to the method-operator.

In another embodiment of the invention, the Process 500 is altered to provide for cyber identity validation during in-person interactions. Step 501 is modified to provide for the use of a device controlled by the Third-Party Entity 201 on-site at the third-party entity's location. In this case, Step 508 is again unnecessary as the Third-Party Entity 201 has already been identified to the method-operator via the third-party entity controlled device used to read/accept the Security Token 205.

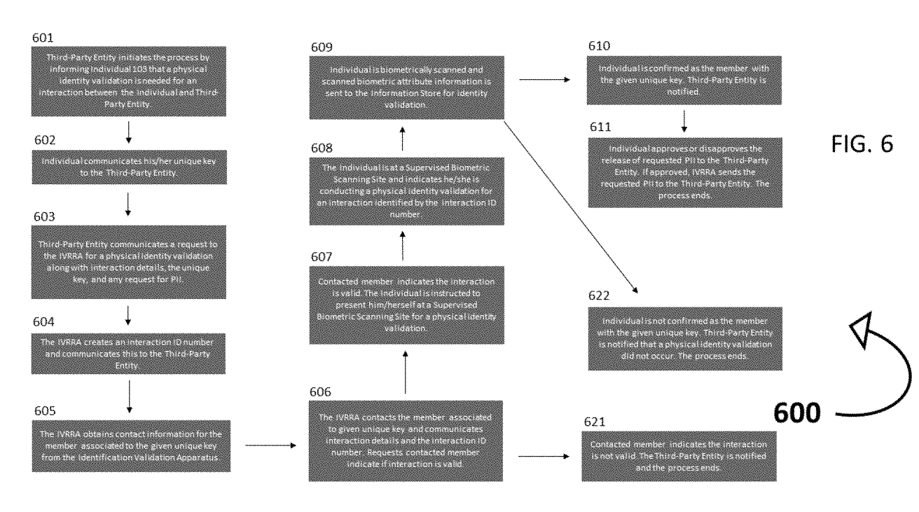

FIG. 6 is a simplified flow diagram illustrating the Physical Identity Validation Process 600 for the Universal Identity Validation Method, according to one embodiment of the invention. The Physical Identity Validation Process 600 enables an Individual 103 to validate his/her identity for an interaction with a Third-Party Entity 101 via a supervised biometric scan at a Supervised Biometric Scanning Site 111, 112, or 113. At step 601, the Third-Party Entity 101 initiates the Process 600 by informing the Individual 103 that a physical identity validation is needed for an interaction between the Individual 103 and Third-Party Entity 101. At step 602, the Individual 103 communicates his/her unique key to the Third-Party Entity 101. At step 603, the Third-Party Entity 101 requests a physical identity validation through the Identity Validation Request Reception Apparatus (IVVRA) 102. The Third-Party Entity 101 communicates the unique key given by Individual 103, interaction details, and any request for personally identifiable information (PII). At step 604, the IVVRA 102 creates an interaction ID number and communicates this to the Third-Party Entity 101. At step 605, the IVVRA 102 obtains contact information for the member associated to the given unique key from the Identification Validation Apparatus 110. The Identification Validation Apparatus 110 requests this information from the Information Store 114 and transmits it to the IVRRA 102. At step 606, the IVRRA 102 contacts the member associated to the given unique key and communicates interaction details and the interaction ID number. Interaction details could include information regarding the Third-Party Entity 101, PII items requested by Third-Party Entity 101, date/time of the interaction, and the nature of the interaction. Contacted member is requested to indicate the validity of the interaction. At step 621, the contacted member indicates that the interaction is not valid. The Third-Party Entity 101 is notified and the process ends. At step 607, the contacted person indicates the interaction is valid. The contacted member is presumed to be Individual 103. Individual 103 is instructed to execute a physical identity validation by presenting him/herself at a Supervised Biometric Scanning Site 111, 112, or 113 for a supervised biometric scan. At step 608, Individual 103 is at Supervised Biometric Scanning Site 111, 112, or 113 and indicates to the method-operator that he/she is conducting a physical identity validation for an interaction identified by the interaction ID number. At step 609, enough biometric attribute information is collected from Individual 103 at Supervised Biometric Scanning Site 111, 112, or 113 for accurate validation of identity. Scanned biometric data is communicated to the Information Store 114 and matched against the biometric attribute information for the record associated to given unique key. Proceed to step 610 or 622. At step 610, the Individual 103 is confirmed as the member with the given unique key. The Third-Party Entity 101 is notified that a physical identity validation occurred affirming the validity of the interaction identified by the interaction ID number. At step 611, Individual 103 approves or disapproves release of requested PII to the Third-Party Entity 101. If approved, the method-operator communicates receipt of the approval to the Information Store 114. The Identification Validation Apparatus 110 communicates the PII to the IVRRA 102, which transmits the PII to the Third-Party Entity 101. The process ends. At step 622, Individual 103 is not confirmed as the member with the given unique key. Third-Party Entity 101 is notified that a physical identity validation did not occur for the interaction identified by the interaction ID number.

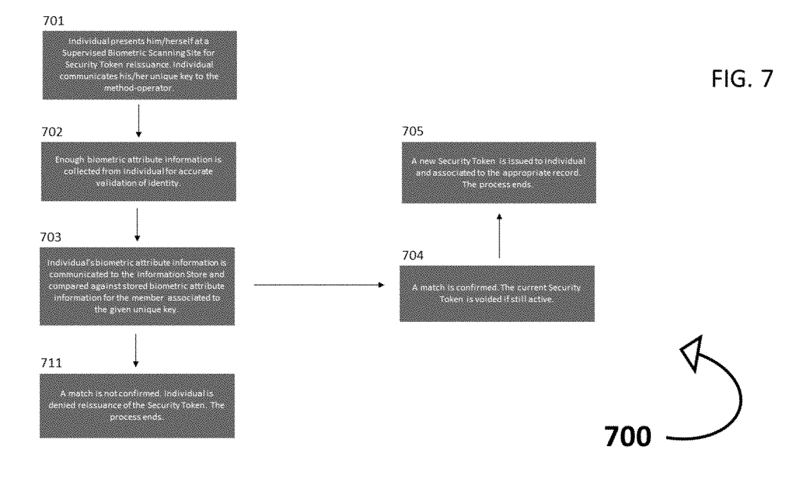

FIG. 7 is a simplified flow diagram illustrating the Reissuance of a Security Token Process 700 for the Universal Identity Validation Method, according to one embodiment of the invention. The Process 700 is utilized if the Individual 204 requires a new Security Token 205 due to inoperability, damage, loss, and/or theft of the currently active Security Token 205; an improvement in security token technology; or for some other reason. At step 701, Individual 204 presents him/herself at a Supervised Biometric Scanning Site 211, 212, or 213 for reissuance of the Security Token 205. Individual 204 communicates his/her unique key to the method-operator. At Step 702, enough biometric attribute information is collected from Individual 204 during a supervised biometric scan at Supervised Biometric Scanning Site 211, 212, or 213 for accurate validation of identity. At Step 703, scanned biometric data is communicated to the Information Store 114 and compared against the biometric attribute information on-record for the member associated to the given unique key. At Step 711, a match is not confirmed and Individual 204 is denied reissuance of the Security Token 205. The process ends. At Step 704, a match is confirmed. The current Security Token 205 associated to this member is voided if still active. At Step 705, a new Security Token 205 is issued to Individual 204 and associated to the record identified by the given unique key in the Information Store 214. The process ends.

### ADVANTAGES OF THE SYSTEM

The description of advantages might assume certain embodiments of the invention for a more specific description of the advantages of the invention as described in this patent application, but these descriptions of advantages are not intended to limit any of the claims made.

Some private-sector and government actors have begun using biometric attribute capture technology to further safeguard and reinforce the integrity of the identity validation process, but the manner in which these protocols have been implemented continues to leave identity validation processes open to abuse. For example, a mobile phone application might use fingerprint data and/or facial data gathered through capabilities organic to the phone. A malicious actor could “trick” the mobile phone into reading fingerprint and/or facial biometric data which was instead programmatically fed to the application using stolen biometric data. Perhaps this individual lost his/her biometric data in a large-scale hacking incident. Recently, a US government agency, the US Office of Personnel Management (OPM), was penetrated by an unauthorized actor and over 5 million fingerprints were reportedly compromised. Or, perhaps this individual was specifically targeted by a malicious actor and his/her biometric attribute information was surreptitiously collected during the individual's normal day-to-day activities. As was mentioned in the introduction of this application, using a high-powered camera to take a picture and/or using basic finger-print detection equipment after someone makes contact with a surface would provide the malicious actor with enough biometric data to fraudulently assume identity. Therefore, the use of biometric data within the current paradigm does not solve the identity problem.

The Universal Identity Validation System and Method (UIVSM) provides for supervised biometric scanning of individuals to accurately validate identity. The supervised biometric scanning would occur at numerous sites, fixed or mobile in nature, controlled by the method-operator. Therefore, the scanning could be done with the very best biometric capture technology available. The equipment could be controlled and physically secured, ensuring the equipment is not modified for malicious purposes. Furthermore, high-end biometric capture technology includes counter-measure technology to ensure individuals subject to biometric scanning are not using tools such as silicon fingerprints or contact eye lenses, for example, which could violate the integrity of the biometric scan. Since the biometric scan will be supervised, the biometric scanning subject may be physically inspected.

The supervised biometric scanning process will gather enough biometric data to positively identify a person with an incredibly high level of accuracy. In one embodiment of this invention, three biometric attributes will be scanned to positively identify a subject: the irises, the fingerprints, and the face. In another embodiment, DNA analysis provides the biometric basis of identity.

A database—one embodiment of the information store referenced in the claims and specification—could be utilized to maintain the biometric attribute information of enrolled members. During initial enrollment, the captured biometric attributes will be compared against all existing records to ensure a match is not identified. If a match is not found, the biometric data will be stored as a new record in the database along with a generated unique key. The unique key mentioned in the claims and specification is essentially a primary key for the database and each set of unique biometric attributes enrolled in the UIVSM will be associated to a unique key. There is no need for the member or method-operator to maintain confidentiality of this key. The key is intended to uniquely identify each member and can be given freely to third-party entities with whom the customer needs to validate his/her identity. In many ways, the UIVSM unique key could serve the purposes of the social security number (SSN) as used in the United States at the time of this patent application but without the requirement to treat the UIVSM unique key with the confidentiality generally granted to a SSN. This is because knowledge of the UIVSM unique key would not be used validate the identity of the possessor of this knowledge. Knowing the unique key and/or some associated PII would not be used to validate identity. The unique key is the primary key for a member's record in the UIVSM information store and nothing more.

After enrollment, the collected information could be maintained in perpetuity. The method-operator could suspend identity validation services for a member if requested to do so by, but the record could be maintained. A nondeletion policy promotes the UIVSM's goal of accurately and consistently validating identity. If the UIVSM method-operator were to purge a record, this individual could re-enroll into the system (without the method-operator's knowledge), receive a new unique key, and associate a new set of personally identifiable information to this record. If a member does withdraw and later attempts to enroll (again) into the UIVSM, he/she will be recognized as a previous member and will be associated to his/her prior existing record.

An enrollee could present false personally identifiable information (PII). To buttress the accuracy of personally identifiable information, the method-operator could compare submitted PII against government and private party databases. Furthermore, submitted PII could be maintained in perpetuity. Therefore, if a fallacious social security number (SSN) were submitted, this introduction of false PII remains with the record. If this person's legitimate SSN is later made known to the method-operator, the record would be appended with the valid social security, but the previous false submission of PII would not be deleted. If the erroneous submission of PII were used to facilitate fraud, the biometric attribute information on-record with the UIVSM could be provided to appropriate personnel and organizations for criminal prosecution and/or civil litigation purposes. The nature of the UIVSM would tend to deter entry of knowingly fraudulent submissions of personally identifiable information (PII).

The method-operator could publish, via a website or other public forum, an element of personally identifiable information—such as a social security number—that would let others know (third-party entities, other individuals, etc.) that the person associated to this element of PII is now enrolled in the UIVSM. If member social security numbers were publicly published, a third-party entity such as a credit card company could ascertain that the submitter of a credit card application is a UIVSM member and therefore the credit card company could validate the authenticity of the application through the UIVSM. One element of PII such as a SSN is not enough PII for others to use fraudulently, as anyone could potentially produce a valid SSN by randomly generating a 9-digit number. Therefore, publishing a single element of PII would not risk additional fraudulent activity but is an efficient technique to let marketplace actors know that the person associated to this element of PII is protecting his/her identity from fraudulent activity through the UIVSM. This publishing would also deter the false submission of PII. For example, if an enrolled individual claims a false SSN, the person associated to the SSN might eventually learn that his/her SSN is being used fraudulently by a member of the UIVSM through the public publishing, and he/she could contact the UIVSM method-operator about this issue.

As the UIVSM gains marketplace acceptance, the size of the enrolled population will become very large, potentially encompassing most or all individuals within the United States and elsewhere. As enrolled membership increases, it will become more difficult for a malicious actor to associate his/her biometric data to fraudulent PII because the target population of PII records (PII associated to individuals not already enrolled in the UIVSM) will diminish. A malicious actor could only target PII not associated to enrolled members. As the system becomes all encompassing, false association of biometric data to PII will not be possible. At this point, identity will no longer be established by PII but instead by biometric attributes.

The UIVSM validates the identity of members for third-party entities by biometrically scanning these individuals at one of many geographically dispersed sites. On a day-to-day basis, an individual's identity cannot be validated every time there is a need for validation via a supervised biometric scan at a UIVSM supervised biometric scanning site as this would be impractical, costly, and time-consuming. As described in the claims and specification, the method-operator could issue a security token for identity validation. Importantly, the security token would be physically issued directly to the member at a supervised biometric scanning site after a supervised biometric scan so that the security token is issued to the correct person. The security token could be used by the member to validate his/her identity for interactions with third-party entities. If the issued security token is lost, damaged, stolen, needs to be replaced due to improvement in technology, and/or rendered unusable for some other reason, the member could contact the method-operator to void the currently active security token. The member would then present him/herself at a supervised biometric scanning site for the reissuance of a security token after a supervised biometric scan validates his/her identity.

The UIVSM does not rely on confidentiality of information and therefore could withstand unauthorized disclosure of information, whether that disclosure encompasses PII and/or biometric attribute information. The biometric attribute information, PII data, generated unique keys, and the security token validation mechanisms (information the UIVSM would need to have accessible) could be ascertained by a malicious actor and the UIVSM's capability to conduct identity validation for members on behalf of third-party entities is not degraded. Identity validation could still occur and the malicious actor would not have the ability to fraudulently assume identity within the UIVSM framework. The UIVSM functions without degradation—even if all the data stored within the UIVSM's information store is compromised—because identity is ultimately established by an in-person supervised biometric scan at a physical site controlled by the method-operator. It is not knowledge of biometric information that proves identity but instead physically having those attributes.

Though security tokens must remain confidential, the only copy of the security token is with the member. No other copy of the security token needs to be maintained. If an individual loses his/her security token, a new security token will be issued at a supervised biometric scanning site after a supervised biometric scan validates the identity of the member.

The security token, in one embodiment of the UIVSM, would be a smart-chip like device often found on credit cards as of the date of this application. Such chips utilize public-private key pair cryptography to validate the authenticity of the security token. The method-operator would maintain the associated public key(s) while the private key(s) would be embedded onto a smart-chip like device. The only copy of the private key(s) would be on the smart-chip device issued directly to the enrolled individual. If a malicious actor were to obtain access to centrally stored information—the public keys, the biometric data, and/or the associated PII—the UIVSM's capability to properly validate identity is not degraded. Access to the public keys provides the capability to authenticate the validity of a private key, but only the private key can be used to authenticate identity. Therefore, a centralized database of private keys would not exist. If an individual requires a reissuance of the security token, the individual will be issued a new security token (with a new public/private key pair) after a supervised biometric scan at a supervised biometric scanning site.

Smart-chip devices are currently designed in such a way as to make it incredibly difficult for malicious actors to obtain the encoded private key. A malicious actor would have to establish contact with the smart-chip, either through physical access, wireless access, or through a network-connected device contemporaneously in contact with the smart-chip. If a malicious actor did obtain the private key, this intrusion would only affect one person and not millions of persons such as has been the case with recent hacking incidents involving large companies and government agencies.

To authenticate the security token, a computer or mobile phone could interface with the smart chip through a variety of protocols. In one embodiment, computers, cell phones, and other appropriate devices could be connected to the smart-chip like device via a Bluetooth/NFC based connection. The member could authenticate him/herself via a website portal or an app-based portal provided by the UIVSM method-operator using the security token, at which point the member's identity has been validated. In one embodiment of the invention, the member could then be passed onto other websites or applications (controlled by third-party entities) via a protocol such as OpenID Connect.³ While passing the member to a third-party entity, other appropriate PII could also be given to the third-party entity. The third-party entity would be in a position to trust that the user really is the person so claimed. Therefore, the user experience with the third-party entity is improved since the user does not have to “prove” his/her identity. ³ See openid.net. OpenID protocols such as OpenID Connect are promoted by the non-profit OpenID Foundation and allows users to be authenticated by co-operating sites using a third-party service, eliminating the need for webmasters to provide their own ad hoc login systems, and allowing users to log into multiple unrelated websites without having to have a separate identity and password for each.

The security token could be lost or stolen, at which point someone else could attempt to fraudulently use it⁴. To prevent this, other embodiments of the security token could be implemented. For example, a pin requirement for the smart-chip like security token could be instituted. After a certain number of failed attempts, the security token could become permanently disabled. In another embodiment, the smart-chip like security token could require a pin and a fingerprint scan for authentication. The private key on the security token is still the credential validating the identity of the individual, but the private key could not be activated until the correct pin and fingerprint have been inputted into an instrument housing the security token. The pin requirement would prevent someone from using the security token if they had a copy of the member's fingerprint data, which would provide the information needed to “print” a fake fingerprint using a 3-D printer. The fingerprint requirement would prevent someone who might know the associated token pin—such as a spouse—from easily using the security token. These are particular embodiments of the security token, and the particular embodiments of the security token will change as available technology evolves. The underlying claim of the invention, though, relies on the utilization of a security token, issued directly to the person after a supervised biometric scan at one of the method-operator supervised biometric scanning sites for validation of identity. Nothing that the person knows (a pin) or has on his/her body (biometric attributes such as a fingerprint) is used to validate identity during cyber identity validations involving the security token but is instead utilized to better ensure that only the authorized person—the enrolled member who received the security token from the method-operator—is using the security token. ⁴ Members will be encouraged to immediately contact the method-operator if this were to occur, so that the active security token is quickly deactivated.

The above description of the invention utilizes several possible embodiments of the claims to improve the readability of the narrative describing the invention, but many embodiments may be construed from the claims and all possible embodiments within the scope of the claims are intended to be protected by this patent application.

What is claimed is:

1. A system for validating identity of an individual on behalf of a third-party entity in support of an interaction between said individual and said third-party entity comprising:
a. a plurality of physical sites providing supervised biometric scanning services;
b. communication of captured biometric attribute information of said individual and other information between said sites and an information store;
c. storage of said captured biometric attribute information in said information store; and
d. reception of requests for identity validation of said individual from said third-party entity.

2. The system of claim 1, further comprising personally identifiable information associated to said individual stored in said information store.

3. The system of claim 1, further comprising a unique key associated to said individual stored in said information store.

4. The system of claim 2, further comprising a unique key associated to said individual stored in said information store.

5. The system of claim 1, including an apparatus for network-based authentication comprising:
a. a security token associated to said individual;
b. a network-connected security token reading-device;
c. a network-connected apparatus which validates the authenticity of the said security token; and
d. a network connection which provides a means for said security token reading-device and said network-connected apparatus to communicate.

6. The system of claim 5, further comprising personally identifiable information associated to said individual stored in said information store.

7. The system of claim 5, further comprising a unique key associated to said individual stored in said information store.

8. The system of claim 6, further comprising a unique key associated to said individual stored in said information store.

9. A method for validating identity of an individual on behalf of a third-party entity comprising:
a. conducting a supervised biometric scan of said individual at a supervised biometric scanning site;
b. collecting enough biometric attribute information from said individual during said supervised biometric scan to provide for highly accurate and reliable validation of identity upon future supervised biometric scans at a supervised biometric scanning site;
c. comparing said biometric attribute information against all previously collected biometric attribute information stored in an information store to ensure said individual has not been previously enrolled;
d. storing said biometric attribute information in said information store;
e. accepting an identity validation request for said individual from said third-party entity in support of an interaction between said third-party entity and said individual;
f. requesting said individual visit a supervised biometric scanning site for affirmation of said third-party entity interaction;
g. conducting a supervised biometric scan of said individual at a supervised biometric scanning site;
h. validating identity through a comparison of scanned biometric attribute information to biometric attribute information stored in said information store;
i. presenting identifying details of said interaction to said individual for affirmation; and
j. receiving affirmation from said individual regarding veracity of said interaction.

10. The method of claim 9, further comprising:
a. collecting personally identifiable information from said individual;
b. storing said personally identifiable information in said information store and associating to said individual; and
c. providing or verifying said personally identifiable information for said third-party entity.

11. The method of claim 9, further comprising:
a. generating a unique key for said individual;
b. storing said unique key in said information store and associating to said individual; and
c. providing or verifying said unique key for said third-party entity.

12. The method of claim 10, further comprising:
a. generating a unique key for said individual;
b. storing said unique key in said information store and associating to said individual; and
c. providing or verifying said unique key for said third-party entity.

13. A method for validating identity of an individual on behalf of a third-party entity comprising:
a. conducting a supervised biometric scan of said individual at a supervised biometric scanning site;
b. collecting enough biometric attribute information from said individual during said supervised biometric scan to provide for highly accurate and reliable validation of identity upon future supervised biometric scans at a supervised biometric scanning site;
c. comparing said biometric attribute information against all previously collected biometric attribute information stored in an information store to ensure said individual has not been previously enrolled;
d. storing said biometric attribute information in said information store;
e. issuing a security token, associated to said individual, to said individual at said supervised biometric scanning site after said supervised biometric scan;
f. using said security token for an interaction with said third-party entity to validate identity; and
g. reissuing a security token at a supervised biometric scanning site to said individual, after a supervised biometric scan validates identity, when such reissuance is necessary or desired due to loss, theft, and/or damage of said security token; changes in security token technology; and/or for other reasons.

14. The method of claim 13, further comprising:
a. collecting personally identifiable information from said individual;
b. storing said personally identifiable information in said information store and associating to said individual; and
c. providing or verifying said personally identifiable information for said third-party entity.

15. The method of claim 13, further comprising:
a. generating a unique key for said individual;
b. storing said unique key in said information store and associating to said individual; and
c. providing or verifying said unique key for said third-party entity.

16. The method of claim 14, further comprising:
a. generating a unique key for said individual;
b. storing said unique key in said information store and associating to said individual; and
c. providing or verifying said unique key for said third-party entity.
